(19) United States
(12) Patent Application Publication
(10) Pub. No.: US 2023/0322103 A1
(43) Pub. Date: Oct. 12, 2023

(54) CABLE ASSEMBLY FOR ELECTRIC VEHICLE TO ELECTRIC VEHICLE CHARGING

(71) Applicant: GM GLOBAL TECHNOLOGY OPERATIONS LLC, Detroit, MI (US)

(72) Inventors: Sharon Hornstein, Pardes Hanna (IL); Klaus Trangbaek, Ein Vered (IL)

(73) Assignee: GM GLOBAL TECHNOLOGY OPERATIONS LLC, Detroit, MI (US)

(21) Appl. No.: 17/714,433

(22) Filed: Apr. 6, 2022

(51) Int. Cl. B60L 53/18; B60L 53/57; B60L 53/65; B60L 53/66; H02J 7/34

(52) U.S. Cl. CPC B60L 53/18; B60L 53/57; B60L 53/65; B60L 53/66; H02J 7/342

(57) ABSTRACT

A charging cable assembly for charging a first plug-in electric vehicle (PEV) from a second PEV includes first and second female sockets for connecting the first and second PEVs. The cable assembly additionally includes a charging station emulator for providing two-way communication between the first and second PEVs and monitoring ability of the first PEV to accept a charge and ability of the second PEV to supply the charge. The cable assembly further includes an electrical cable bundle having a first distal end connected to the first female socket and a second distal end connected to the second female socket. The cable bundle is in electrical communication with the charging station emulator and is configured to transmit the charge and provide two-way communication between the first and second PEVs.

### INTRODUCTION

The present disclosure relates to a cable assembly for charging one electric vehicle from another electric vehicle.

An electric vehicle, also called an EV, uses one or more electric or traction motors for propulsion. An electric vehicle may be powered through a collector system by electricity from off-vehicle sources, or may be self-contained with a battery, solar panels, or an electric generator to convert fuel to electricity.

A plug-in electric vehicle (PEV) is a motor vehicle that includes a rechargeable battery pack that may be recharged from an external source of electricity, such as a wall socket, while the electricity stored in the rechargeable battery pack drives or contributes to driving the wheels. PEV is a subcategory of electric vehicles that includes all-electric or battery electric vehicles (BEVs), plug-in hybrid vehicles (PHEVs), and electric vehicle conversions of hybrid electric vehicles and internal combustion engine vehicles, A hybrid electric vehicle (HEV) combines a conventional (usually fossil fuel-powered) powertrain with some form of electric propulsion.

PEVs may charge from industrial or residential power outlets, such as overnight at a PEV user's residence, a process intended to give a sufficient charge for normal everyday usage. A PEV may also be charged from a dedicated charging station, such as while the PEV's user is at work, and be left to charge throughout the day, extending possible range of a commute and eliminating range anxiety.

### SUMMARY

A charging cable assembly for electrically connecting a first plug-in electric vehicle (PEV) to a second PEV to charge the first PEV from the second PEV includes a first female socket configured to connect to one of the first PEV and the second PEV. The charging cable assembly also includes a second female socket configured to connect to the other of the first PEV and the second PEV. The charging cable assembly additionally includes a charging station emulator providing two-way communication. The charging station emulator is configured to monitor ability of the first PEV to accept a charge and ability of the second PEV to supply the charge. The charging station emulator is also configured to communicate, to the first PEV, the ability of the second PEV to supply the charge. The charging station emulator is further configured to communicate, to the second PEV, the ability of the first PEV to accept the charge. The cable assembly further includes an electrical cable bundle having a first distal end connected to the first female socket and a second distal end connected to the second female socket. The electrical cable bundle is in electrical communication with the charging station emulator and is configured to transmit the charge from the second PEV to the first PEV and provide two-way communication between the first and second PEVs.

Each of the first and second PEVs may include a respective traction motor configured to generate EV propulsion torque and an EV electrical system including a rechargeable battery configured to generate electrical current for powering the traction motor. The charging cable assembly as described above is configured to draw the charge from the rechargeable battery of the second PEV to supply the charge to the rechargeable battery of the first PEV.

The second PEV may have a capability to return power to an electrical charging grid via a charging station. In such an embodiment, the charging station emulator may be configured to monitor the ability of the second PEV to supply the charge via at least monitoring the capability of the second PEV to return power to the electrical charging grid.

Communication of the ability of the second PEV to supply the charge may include sending to the first PEV a first signal indicative of an electrical resistance of the second PEV. The first signal may be a first pulse width modulated (PWM) signal.

Monitoring of the ability of the first PEV to accept the charge may include identifying an electrical resistance of the first PEV.

Communication of the ability of the first PEV to accept the charge may include sending to the second PEV a second signal indicative of the electrical resistance of the first PEV. The second signal may be a second pulse width modulated (PWM) signal or a digital signal.

The electrical cable bundle may include a high-power cable configured to transmit the charge and a low-power cable configured to provide two-way communication between the first and second PEVs.

The charging station emulator may be additionally configured to detect an electrical connection of the first PEV to the second PEV via the electrical cable bundle and monitor continuity of the electrical connection of the first PEV to the second PEV.

The charging cable assembly may additionally include a theft preventive lock configured to minimize likelihood of misappropriation and unauthorized use of the charging cable assembly.

The theft preventive lock may include a mechanical lock to selectively fasten/unfasten the charging cable assembly to one of the first PEV and the second PEV and/or a function regulator configured to selectively enable/disable operation of the charging cable assembly.

The theft preventive lock may be configured to actuate automatically upon connection of the charging cable assembly to one of the first PEV and the second PEV.

Monitoring the ability of the second PEV to supply the charge includes monitoring a state of charge (SOC) of the second PEV.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic perspective view of representative plug-in electric vehicles (PEVs), at least one of which has a capability to return power to an electrical charging grid (V2G), according to the disclosure.

FIG. 2 is a schematic side view of two PEVs to be electrically connected via a charging cable assembly for charging one of the two PEVs via the other of the two PEVs shown in FIG. 1, according to the disclosure.

FIG. 3 is a schematic view of the charging cable assembly shown in FIG. 2, having two individual female sockets connected to respective male sockets of the two PEVs, a charging station emulator, and an electrical cable bundle having a high-power charging cable and a low-power communication cable, according to the disclosure.

FIG. 4 is a schematic close-up view of the charging station emulator and the electrical cable bundle shown in FIG. 3, and a theft-preventive lock, according to the disclosure.

### DETAILED DESCRIPTION

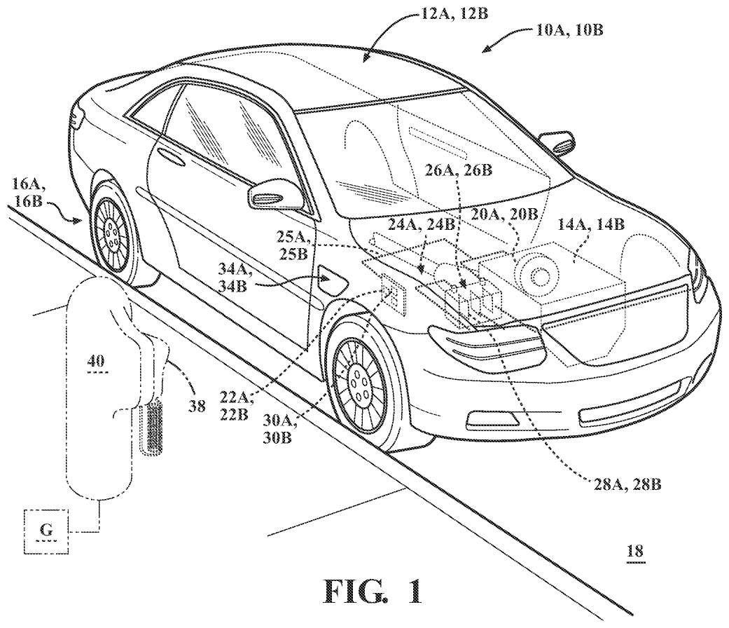

Referring to FIG. 1, a first plug-in electric vehicle (PEV) 10A having a first PEV body 12A and a second PEV 10B having a second PEV body 12B are depicted. Each of the first and second PEVs 10A, 10B may include, but not be limited to, a commercial vehicle, industrial vehicle, passenger vehicle, aircraft, watercraft, train or the like. It is also contemplated that each of the first and second PEVs 10A, 10B may be a mobile platform, such as an airplane, all-terrain vehicle (ATV), boat, personal movement apparatus and the like to accomplish the purposes of this disclosure.

As shown in FIG. 1, the first and second PEV 10A, 10B include powertrains having respective power-sources 14A, 14B. Power-sources 14A, 14B are configured to generate respective power-source torque for propulsion of the corresponding first and second PEVs 10A, 10B via respective driven wheels 16A, 16B relative to a road surface 18. The power-sources 14A, 14B are depicted as having respective electric motor-generators or traction motors 20A, 20B. Although not shown, each of the respective powertrains of the first and second PEV 10A, 10B may also include an additional or auxiliary power-source, such as an internal combustion engine, to act in concert with the respective power-sources 14A, 14B to power the corresponding first and second PEVs.

As shown, the first PEV 10A additionally includes a programmable electronic controller 22A and a first PEV electrical system 24A, while the second PEV 10B includes a programmable electronic controller 22B and a second PEV electrical system 24B. Each of the electrical systems 24A, 24B is connected to the respective power-source 14A, 14B, to the respective electronic controller 22A, 22B, as well as to other vehicle systems, via a respective high-voltage BUS 25A and 25B. As shown in FIG. 1, the electrical systems 24A, 24B include respective battery modules 26A, 26B, each having one or more rechargeable energy storage cells or batteries 28A, 28B. The battery modules 26A, 26B are configured to generate electrical current for powering the corresponding traction motors 20A, 20B and supply electrical energy to the respective auxiliary power-sources. The individual electronic controllers 22A, 22B may be programmed to control the respective power-sources 14A, 14B, the electrical systems 24A, 24B, and various other vehicle systems, such as lighting, infotainment, and heating ventilation and air conditioning (HVAC).

Specifically, each electronic controller 22A, 22B may be configured as a vehicle body controller or a central processing unit (CPU) programmed to regulate various systems and functions of the corresponding vehicle 10A, 10B. To such an end, each of the electronic controllers 22A, 22B includes a respective processor and tangible, non-transitory memory, for example with instructions for operation of the corresponding power-sources 14A, 14B, and the electrical systems 24A, 24B programmed therein. The memory may be an appropriate recordable medium that participates in providing computer-readable data or process instructions. Such a recordable medium may take many forms, including but not limited to non-volatile media and volatile media. Non-volatile media for the respective electronic controllers 22A, 22B may include, for example, optical or magnetic disks and other persistent memory. Volatile media may include, for example, dynamic random-access memory (DRAM), which may constitute a main memory.

Operating instructions may be transmitted by one or more transmission mediums, including coaxial cables, copper wire and fiber optics, including the wires that comprise the respective system BUS 25A, 25B coupled to a processor of the corresponding electronic controller 22A, 22B, or via a wireless connection. Memory of the respective electronic controllers 22A, 22B may also include a flexible disk, hard disk, magnetic tape, another magnetic medium, a CD-ROM, DVD, another optical medium, etc. The electronic controllers 22A, 22B may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by each electronic controller 22A, 22B or accessible thereby may be stored in the corresponding memory and automatically executed to provide the required functionality of the corresponding power-source 14A, 14B, and the electrical system 24A, 24B.

The electronic controller 22A, 22B may be specifically configured, i.e., programmed, to detect a respective request 30A, 30B for charging the corresponding battery module 26A, 26B. The request 30A, 30B for charging the battery module 26A, 26B may be the result of detection of the respective battery module's state of charge (SOC) having dropped below a predetermined SOC, i.e., a detected low SOC, and include a sensory signal displayed on an instrument panel of the corresponding PEV 10A, 10B. In response to the detected low SOC, a user of the corresponding PEV 10A or 10B may be prompted to search for a source of electrical charge, such as an electrical outlet connected to a charging grid G.

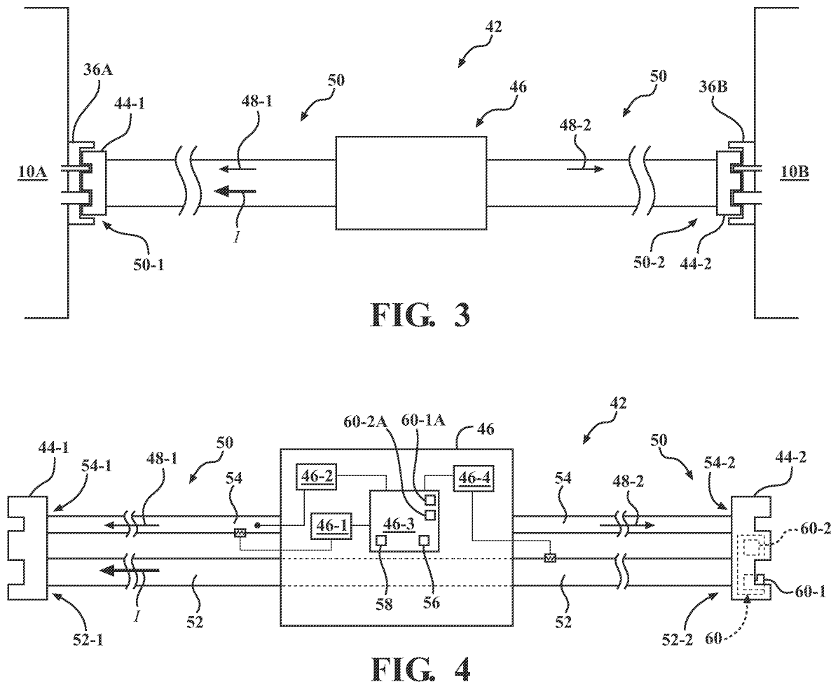

The respective electronic controller 22A, 22B may then command a specific rate of charge of the corresponding battery module 26A, 26B by setting a value of charging current flowing into the subject battery module in response to the detected request 30A or 30B. The first PEV 10A additionally includes a charge port module 34A, while the second PEV 10B includes a charge port module 34B. As shown in FIG. 1, each of the charge port modules 34A, 34B includes a corresponding male connector 36A, 36B (shown in FIG. 3). Each male connector 36A, 36B is configured to accept a charging plug 38 (shown in FIG. 1) connected to an external source 40 of electricity, such as a charging station connected to an electrical charging grid G, and thereby accept the charging current for recharging the respective battery module 26A, 26B of the corresponding first and second PEVs 10A, 10B.

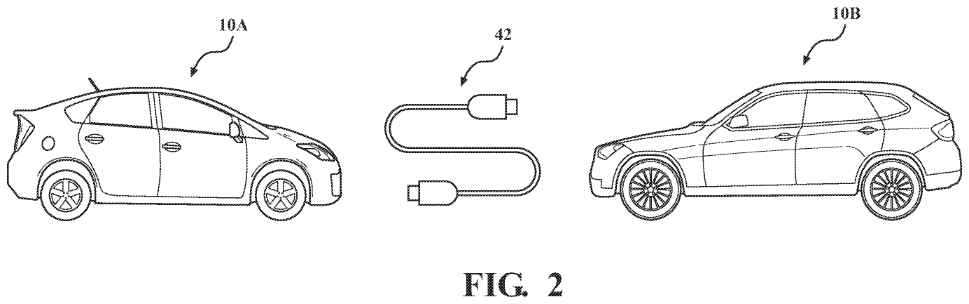

FIGS. 2-4 illustrate a charging cable assembly 42 for electrically connecting the first PEV 10A to the second PEV 10B for charging the first PEV via or from the second PEV. With specific reference to FIGS. 3-4, the charging cable assembly 42 includes a first female socket 44-1 configured to connect to one of the first PEV 10A and the second PEV 10B. The charging cable assembly 42 also includes a second female socket 44-2 (shown in FIGS. 3-4) configured to connect to the other of the first PEV 10A and the second PEV 10B. Accordingly, each of the first and second female sockets 44-1, 44-2 are adapted to connect to either of the first and second PEVs 10A, 10B. Specifically, the first and second female sockets 44-1, 44-2 may physically and electrically connect to either the male connector 36A of the first PEV 10A or the male connector 36B of the second PEV 10B. As additionally shown in FIGS. 3-4, the charging cable assembly 42 additionally includes a charging station emulator 46 configured to monitor ability, e.g., identify readiness, of the first PEV 10A to accept a charge or charging current I and ability of the second PEV 10B to supply the charging current I.

The charging station emulator 46 may be further configured to enable two-way communication between the electronic controllers 22A, 22B, e.g., access the subject electronic controllers' associated algorithms, of the respective first and second PEVs 10A, 10B. Accordingly, the charging station emulator 46 may communicate the ability of the first PEV 10A to accept the charge to the second PEV 10B and communicate to the first PEV 10A the ability of the second PEV 10B to supply the charging current I. Monitoring the ability of the first PEV 10A to accept the charge and the ability of the second PEV 10B to supply the charge may include monitoring respective states of charge (SOCs) of the first PEV and the second PEV. Additionally, monitoring the ability of the first PEV 10A to accept the charging current I may specifically include identifying or determining an electrical resistance of the first PEV, such as via a current sensor 46-1 (shown in FIG. 4) integrated into the charging station emulator 46.

The charging station emulator 46 is also configured to communicate, to the first PEV 10A, the ability of the second PEV 10B to supply the charging current I. Communication of the ability of the second PEV 10B to supply the charging current I may include charging station emulator 46 sending a first signal 48-1 indicative of the electrical resistance of the second PEV to the first PEV 10A, e.g., to the electronic controller 22A. The charging station emulator 46 may include an integrated generator 46-2 of pulse width modulated (PWM) signals. The first signal 48-1 may be a first PWM signal created via the PWM generator 46-2. The charging station emulator 46 is additionally configured to communicate, to the second PEV 10B, the ability of the first PEV 10A to accept the charging current I. Communication of the ability of the first PEV 10A to accept the charging current I may include sending a second signal 48-2 indicative of the electrical resistance of the first PEV to the second PEV 10B, e.g., to the electronic controller 22B. The second signal 48-2 may be a digital signal or a second PWM signal created and sent via the generator 46-2.

The charging cable assembly 42 additionally includes an electrical cable bundle 50 having a first distal end 50-1 connected to the first female socket 44-1 and a second distal end 50-2 connected to the second female socket, 44-2. The electrical cable bundle 50 is in electrical communication with the charging station emulator 46 and is configured to transmit the charging current I from the second PEV 10B to the first PEV 10A and provide two-way or bi-directional communication between the first and second PEVs. The use of the charging cable assembly 42 to charge the first PEV 10A from the second PEV 10B may be facilitated by the second PEV having a capability to return power to the electrical charging grid G (V2G), such as via the charging station 40. When the charging cable assembly 42 is used with such an embodiment of the second PEV 10B, the charging station emulator 46 may be configured to monitor the ability of the second PEV to supply the charging current I via at least monitoring the capability of the second PEV 10B to return power to the electrical charging grid G.

As shown in FIG. 4, the electrical cable bundle 50 may include a high-power cable 52 having respective first and second ends 52-1, 52-2. The high-power cable 52 is configured to transmit the charging current I from the second PEV 10B to the first PEV 10A. The electrical cable bundle 50 may also include a low-power cable 54 having respective first and second ends 54-1, 54-2. The low-power cable 54 is configured to provide two-way communication between the first and second PEVs 10A, 10B via the PWM signal generator 46-2, e.g., the first pulse width modulated (PWM) signal 48-1 and the second PWM signal 48-2. The current sensor 46-1 may be arranged on the low-power cable 54 and configured to determine the electrical resistance of the first PEV 10A. While the high-power cable 52 connects directly between the PEVs 10A, 10B, the first and second ends 54-1, 54-2 of the low-power cable 54 may be connected via electronics in the emulator 46. Monitoring the ability of the second PEV 10B to supply the charging current I may include determining an electrical resistance of the second PEV by measuring the charging current on the low power line 54 connection between the charging station emulator 46 and the second PEV. The charging station emulator 46 may use a digital communication protocol for monitoring the charging current I supplied by the second PEV 10B.

The charging station emulator 46 may additionally include an emulator processing unit (EPU) 46-3 (shown in FIG. 4) configured to process incoming data signals and regulate two-way communication transmitted via the low-power cable 54. Specifically, the EPU 46-3 may be configured to detect an established electrical connection 56 of the first PEV 10A to the second PEV 10B via the electrical cable bundle 50, such as using a signal from the current sensor 46-1. It is envisioned that PEVs 10A and 10B will individually monitor the charging current I transmitted between the subject vehicles. However, an additional current sensor 46-4 configured to detect the charging current I transmitted between the first and second PEVs 10A, 10B may be arranged on the high-power cable 52 and in communication with the EPU 46-3 to supplement the monitoring of the charging current I via the two vehicles. The charging station emulator 46 may also be configured to monitor continuity of the electrical connection 56 between the first and second PEVs 10A, 10B. The charging station emulator 46 may be further configured to communicate the detected established electrical connection 56 to each of the first and second PEVs 10A, 10B. Additionally, the charging station emulator 46 may be configured to generate and communicate an alert 58 to one or both of the first and second PEVs 10A, 10B when the continuity of the electrical connection 56 has been severed.

With continued reference to FIG. 4, the charging cable assembly 42 may additionally include a theft-preventive lock 60. The theft-preventive lock 60 is configured to minimize likelihood of misappropriation and unauthorized use of the charging cable assembly 42. Deployment of the theft-preventive lock 60 is intended to be controlled by the owner of the charging cable assembly 42, such that the use of the charging cable assembly 42 may be authorized by the same individual. The theft-preventive lock 60 may include a mechanical lock 60-1 configured to fasten the charging cable assembly 42 to one of the first PEV 10A and the second PEV 10B. The mechanical lock 60-1 may be selectively activated/deactivated via a physical key, such as at either the first or the second female socket 44-1, 44-2 (depending on which vehicle user owns the charging cable assembly 42). Alternatively, the mechanical lock 60-1 may be selectively activated/deactivated via an electronic key, such as a numerical code 60-1A programmed into the EPU 46-3 of the charging station emulator 46, and input either remotely or at the charging cable assembly 42.

The mechanical lock 60-1 may be configured to maintain attachment of the charging cable assembly 42 to at least one of the first and second PEVs 10A, 10B until the authorized charging has been completed. Such attachment may be useful for thwarting removal of the charging cable assembly 42 without the owner's authorization and knowledge. For example, if the owner of the charging cable assembly 42 is also the owner or user of the second PEV 10B, the charging cable assembly 42 may be physically connected and locked to the second PEV, such as by the charging cable assembly's owner. In such an instance, the charging cable assembly 42 may remain physically attached to the second PEV 10B via the mechanical lock 60-1 until the user of the second PEV deactivates the mechanical lock, for example, after completion of the charging event. Thus, the mechanical lock 60-1 may permit the charging cable assembly 42 to be physically disconnected from the first PEV 10A, allowing the first PEV to depart if desired, despite remaining attached to the second PEV 10B.

In addition to or in place of the mechanical lock 60-1, the theft preventive lock 60 may include a function regulator 60-2 (shown in FIG. 4). The function regulator 60-2 is configured to selectively enable/disable operation of the charging cable assembly 42, such as via controlling the electrical connection of the first PEV 10A to the second PEV 10B, and thus the ability of the charging cable assembly 42 to supply the charging current I. The function regulator 60-2 may be in operative communication with the charging station emulator 46. Specifically, the function regulator 60-2 may be controlled via a pass code 60-2A programmed into the EPU 46-3. The pass code 60-2A may be physically input at the charging station emulator 46, at either the first or second female socket 44-1, 44-2, or remotely, such as via a mobile device.

In the embodiment of the charging cable assembly 42 having the function regulator 60-2 but not the mechanical lock 60-1, the charging cable assembly 42 may be physically detached from the cable assembly owner's vehicle, but will remain inoperative until the correct pass code 60-2A is entered. The theft preventive lock 60, i.e., each of the mechanical lock and the function regulator 60-1, 60-2, may be configured to actuate or be triggered automatically upon connection of the charging cable assembly 42 to the charging cable assembly 42 owner's vehicle, either the first or the second PEV 10A, 10B. However, in case of the automatically triggered/activated theft preventive lock 60, the mechanical lock 60-1 and/or the function regulator 60-2, is intended to remain under full control of the owner of the charging cable assembly 42.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A charging cable assembly for electrically connecting a first plug-in electric vehicle (PEV) to a second PEV to charge the first PEV from the second PEV, the charging cable assembly comprising:
a first female socket configured to connect to one of the first PEV and the second PEV;
a second female socket configured to connect to the other of the first PEV and the second PEV;
a charging station emulator configured to:
monitor ability of the first PEV to accept a charge and ability of the second PEV to supply the charge;
communicate, to the first PEV, the ability of the second PEV to supply the charge; and
communicate, to the second PEV, the ability of the first PEV to accept the charge; and
an electrical cable bundle having a first distal end connected to the first female socket and a second distal end connected to the second female socket, wherein the electrical cable bundle is in electrical communication with the charging station emulator and is configured to transmit the charge from the second PEV to the first PEV and provide two-way communication between the first and second PEVs.

2. The charging cable assembly of claim 1, wherein the second PEV has a capability to return power to an electrical charging grid via a charging station, and wherein the charging station emulator is configured to monitor the ability of the second PEV to supply the charge via at least monitoring the capability of the second PEV to return power to the electrical charging grid.

3. The charging cable assembly of claim 2, wherein communication of the ability of the second PEV to supply the charge includes sending to the first PEV a first signal indicative of an electrical resistance of the second PEV.

4. The charging cable assembly of claim 1, wherein monitoring of the ability of the first PEV to accept the charge includes identifying an electrical resistance of the first PEV.

5. The charging cable assembly of claim 4, wherein communication of the ability of the first PEV to accept the charge includes sending to the second PEV a second signal indicative of the electrical resistance of the first PEV.

6. The charging cable assembly of claim 1, wherein the electrical cable bundle includes a high-power cable configured to transmit the charge from the second PEV to the first PEV and a low-power cable configured to provide two-way communication between the first and second PEVs.

7. The charging cable assembly of claim 1, wherein the charging station emulator is additionally configured to detect an electrical connection of the first PEV to the second PEV via the electrical cable bundle and monitor continuity of the electrical connection of the first PEV to the second PEV.

8. The charging cable assembly of claim 1, further comprising a theft-preventive lock configured to minimize likelihood of misappropriation and unauthorized use of the charging cable assembly.

9. The charging cable assembly of claim 8, wherein the theft preventive lock includes at least one of a mechanical lock to selectively fasten/unfasten the charging cable assembly to one of the first PEV and the second PEV and a function regulator configured to selectively enable/disable operation of the charging cable assembly.

10. The charging cable assembly of claim 8, wherein the theft preventive lock is configured to actuate automatically upon connection of the charging cable assembly to one of the first PEV and the second PEV.

11. A charging cable assembly for electrically connecting a first plug-in electric vehicle (PEV) to a second PEV to charge the first PEV from the second PEV, the charging cable assembly comprising:
a first female socket configured to connect to one of the first PEV and the second PEV;
a second female socket configured to connect to the other of the first PEV and the second PEV;
a charging station emulator configured to:
monitor ability of the first PEV to accept a charge and ability of the second PEV to supply the charge;
communicate, to the first PEV, the ability of the second PEV to supply the charge; and
communicate, to the second PEV, the ability of the first PEV to accept the charge.
an electrical cable bundle having a first distal end connected to the first female socket and a second distal end connected to the second female socket, wherein the electrical cable bundle is in electrical communication with the charging station emulator and is configured to transmit the charge from the second PEV to the first PEV and provide two-way communication between the first and second PEVs; and
a theft-preventive lock configured to minimize likelihood of misappropriation and unauthorized use of the charging cable assembly.

12. The charging cable assembly of claim 11, wherein the second PEV has a capability to return power to an electrical charging grid via a charging station, and wherein the charging station emulator is configured to monitor the ability of the second PEV to supply the charge via at least monitoring the capability of the second PEV to return power to the electrical charging grid.

13. The charging cable assembly of claim 12, wherein communication of the ability of the second PEV to supply the charge includes sending to the first PEV a first signal indicative of an electrical resistance of the second PEV.

14. The charging cable assembly of claim 11, wherein monitoring of the ability of the first PEV to accept the charge includes identifying an electrical resistance of the first PEV.

15. The charging cable assembly of claim 14, wherein communication of the ability of the first PEV to accept the charge includes sending to the second PEV a second signal indicative of the electrical resistance of the first PEV.

16. The charging cable assembly of claim 11, wherein the electrical cable bundle includes a high-power cable configured to transmit the charge from the second PEV to the first PEV and a low-power cable configured to provide two-way communication between the first and second PEVs.

17. The charging cable assembly of claim 11, wherein the charging station emulator is additionally configured to detect an electrical connection of the first PEV to the second PEV via the electrical cable bundle and monitor continuity of the electrical connection of the first PEV to the second PEV.

18. The charging cable assembly of claim 11, wherein the theft preventive lock includes at least one of a mechanical lock to selectively fasten/unfasten the charging cable assembly to one of the first PEV and the second PEV and a function regulator configured to selectively enable/disable operation of the charging cable assembly.

19. The charging cable assembly of claim 11, wherein the theft preventive lock is configured to actuate automatically upon connection of the charging cable assembly to one of the first PEV and the second PEV.

20. The charging cable assembly of claim 11, wherein monitoring of the ability of the second PEV to supply the charge includes monitoring a state of charge (SOC) of the second PEV.
